(19) United States
(12) Patent Application Publication
(10) Pub. No.: US 2008/0264571 A1
(43) Pub. Date: Oct. 30, 2008

(54) Tape case sealer with built in initial tape cutter

(76) Inventor: Joe Augustine S.T. Lam, Vancouver (CA)

Correspondence Address: C.A. Rowley, Box 59, 51 Riverside Parkway, Frankford, ON, K0K 2C0, CA

(21) Appl. No.: 11/790,502

(22) Filed: Apr. 26, 2007

(51) Int. Cl. B29C 65/00

(52) U.S. Cl. 156/530

(57) ABSTRACT

A tape applicator for taping boxes or the like is provided with a cutting element mounted on the applicator out of the normal path of said tape but relatively positioned to the path so that relative movement between the tape and cutting element at the end of a threading operation to insert a tape into operative position in the applicator severs said tape and defines a free end of a tab at a free end of the tape.

### FIELD OF INVENTION

The present invention relates to an improve tape applicator, more particularly the present invention relates to a tape applicator having a cut off knife for cutting the lead end of a new roll of tape being applied to the applicator

### BACKGROUND OF THE PRESENT INVENTION

Conventional tape applicators or tape heads used for applying adhesive tapes across to a box or carton or the like to seal the box flaps in closed position generally include a front link, having a wiper roll to apply the leading end of the tape to the leading face a carton moved relatively past the tape head, a trailing arm with a wiper roll for wiping the tape on the adjacent surface of the box and along the trailing end of the box and a cut off knife between the two arms and actuated to cut the tape to the proper length and, with a free end adjacent to the wiper roll on the front link in position to be applied to the next box. The applicators are common in the industry and have been found to operate very well. See for example U.S. Pat. No. 5,676,298 issued Oct. 14, 1997 to Lam or U.S. Pat. No. 5,725,721 issued Mar. 10, 1998 to Yeh.

It is also common practice to provide of a cut off knife adjacent to a holding surface in various hand dispensers for adhesive tape (“Scotch tape”) dispensers to facilitate cutting off the tape after application. (see for example U.S. Design patent D502,508 S issued Mar. 1, 2005 to Hung).

When a new tape is hand fed to the taping head as is in most cases the norm the leading end of the tape is pulled from the new roll of tape and positioned adjacent to the wiper roll on the front link and the excess tape which normally will be wrinkled etc., as it is grabbed and used as a handle to pull the tape from the roll and position it relative to the wiper roll is cut of by any suitable means normally a knife edge or a pair scissors. This is not a very effective way to cut the tape as one must have or position the cutting tool and then activate it to cut the tape at the proper location relative to the wiper roll.

### BRIEF DESCRIPTION OF THE PRESENT INVENTION

It is an object of the present invention to provide

Broadly the present invention relates to a tape applicator having a front link and a rear link interconnected by a suitable frame, a first wiper for wiping a sealing tape against a carton being sealed in a tape sealing operation positioned at a free end of said front link remote from said frame, said rear link having a second wiper for wiping said sealing tape against a trailing end of said carton trailing in a direction of movement of said carton relative to said tape applicator during said sealing operation and a cut off knife for cutting said tape at the end of said taping operation, the improvement comprising a cutting element mounted on said front link adjacent to said first wiper but out of the normal path of said tape but relatively positioned to said wiper so that relative movement between said tape and said cutting element at the end of a threading operation to insert a new sealing tape into operative position in said applicator severs said tape and define a free end of a tab at a free end of said tape.

Preferably said first wiper is a flexible pad and said cutting element is positioned on the side of said flexible pad opposite a side of said pad adjacent to a normal path of said sealing tape.

Preferably said cutting element has its cutting edge facing away from said frame.

Preferably said first wiper is composed of a pair of rollers spaced apart sufficiently for said cutting element to extend between them when in a cutting position for cutting said tape

Preferably said cutting element has a cutting edge that is a spring biased to inactive position and is moveable from said inactive position to said cutting position.

### BRIEF DESCRIPTION OF THE SEVERAL VIEWS OF THE DRAWINGS

Further features, objects and advantages will be evident from the following detailed description of the preferred embodiments of the present invention taken in conjunction with the accompanying drawings in which;

FIG. 1 is a schematic illustration with parts omitted showing the Prior Art tape head with a new tape roll being applied.

FIG. 2 is a schematic illustration similar to FIG. 1 but incorporating the preferred embodiment of the present invention.

FIG. 2A is an enlarged view showing the wiper and the cutting element of the FIG. 2 embodiment in greater detail.

FIG. 3 is a schematic illustration similar to FIG. 1 but incorporating another embodiment of the present invention.

FIG. 4 is a schematic illustration similar to FIG. 1 but incorporating a third embodiment of the present invention.

FIG. 5 is a schematic illustration similar to FIG. 1 but incorporating a fourth embodiment of the present invention.

FIG. 5A is an enlarged view showing the wiper and the cutting element of the FIG. 5 embodiment in greater detail.

FIG. 6 is a schematic illustration similar to FIG. 1 but incorporating a fifth embodiment of the present invention.

### DETAILED DESCRIPTION OF THE INVENTION

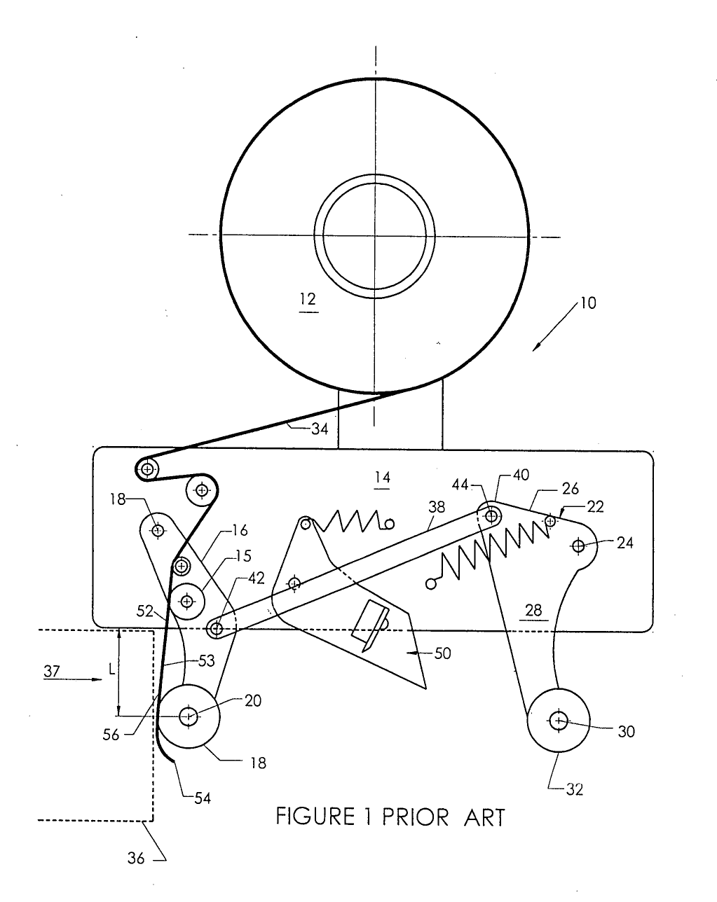

FIG. 1 (Prior Art) shows a taping head 10 that has a roll 12 mounted to the frame 14 of the taping head 10 in conventional manner. The head 10 includes a lead link or arm 16 rotatably mounted on the frame 10 on pin 18 and has a wiper roll 16 rotatably mounted adjacent to its free end 20 extending from the frame 14 (end remote from the pivot pin 18). A trailing link or arm 22 is rotatably mounted on the frame for pivotal movement about pin 24 having an axis of rotation substantially parallel to the axis of pin 18 and spaced there from. The tailing link 22 is formed by a pair of arms 26 and 28 extending from opposite sides of the bearing for or the position of the pivot pin 24. The arm 28 is provide adjacent to its free end 30 extending from the frame 14 with a second wiper roll 32 that functions as is well known to wipe the tape 34 against the trailing end (in the direction of box movement past the taping head 10 as indicated by arrow 37) of a carton or box 36 shown in phantom lines. The arm 26 is connected to the link 16 via a connecting link 38 pivotable connected adjacent its opposite ends to the link 16 and arm 26 (adjacent to its free end 40 on the side of pin 24 remote from end 30) as indicated at 42 and 44 respectively. A spring 46 is shown as the biasing means forcing the free ends 20 and 30 to the left in FIG. 1 to hold the roller 18 in with the carton 36 (i.e. tends to resist movement of the roller 18 in the direction of movement of the box 36 as indicated by the arrow 37). Mounted on the flame 14 between the links 16 and 22 is the cut off mechanism 50 which operated in the well known manner.

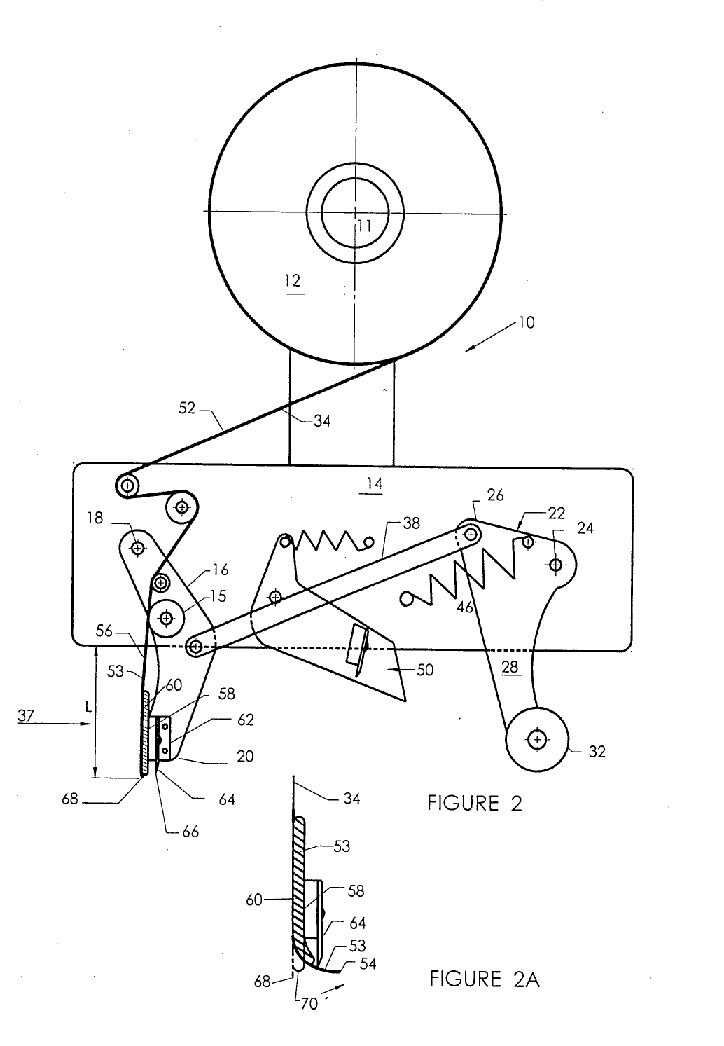

The tape 34 has its sticky or adhesive side 52 facing to the centre of the roll 12 and is drawn off the roll and presented to the carton 36 facing the oncoming box 36 i.e. the non-sticky side of the tape 34 (side opposite the sticky side 52) engages the wiper roll 18. The normal path of the tape as indicated at 53 extends between the guiding roller 15 and the surface of the wiper 18 and in the treading operation to insert a tape generally beyond the roll 18 as indicated at 53a in embodiments shown in FIGS. 2 to 5A.

When a new roll of tape 12 is applied (or obviously, if the tape breaks and must be rethreaded) the tape is threaded around the guide roller and the free end 54 is pulled (normally by hand) to extend beyond the roll 18 and the cut off by hand using a knife or scissors (not shown) to leave a tab 56 having a length L extending between the frame 14 and the roll 20 as indicated.

This tab 56 defines the normal path of the tape relative to the wiper 18 at the free end of the arm 16 after the free end has been removed in normal operation.

The device and the treading and cut off operations as described above are well known and described the current way in which the tape for a new roll is generally applied to the tape head 10.

Like reference numerals have been used to designate like parts throughout the drawings.

The preferred embodiment of the present invention is shown in FIG. 2. The significant change is that the wiper 18 at the free end 20 of the arm or link 16 has be replaced by a wiper pad 60 mounted on arm 16 via a suitable bracket 62. Positioned on the rear side 58 of the wiper 60 opposite to the normal tape path i.e. behind the wiper 60 (ahead in the direction of relative travel of the box as indicated by the arrow 37) is a cutting element 64 the cutting edge 66 of which may be of any suitable form such as a sharp knife edge, a sharp serrated knife edge, plurality of needle points, etc.

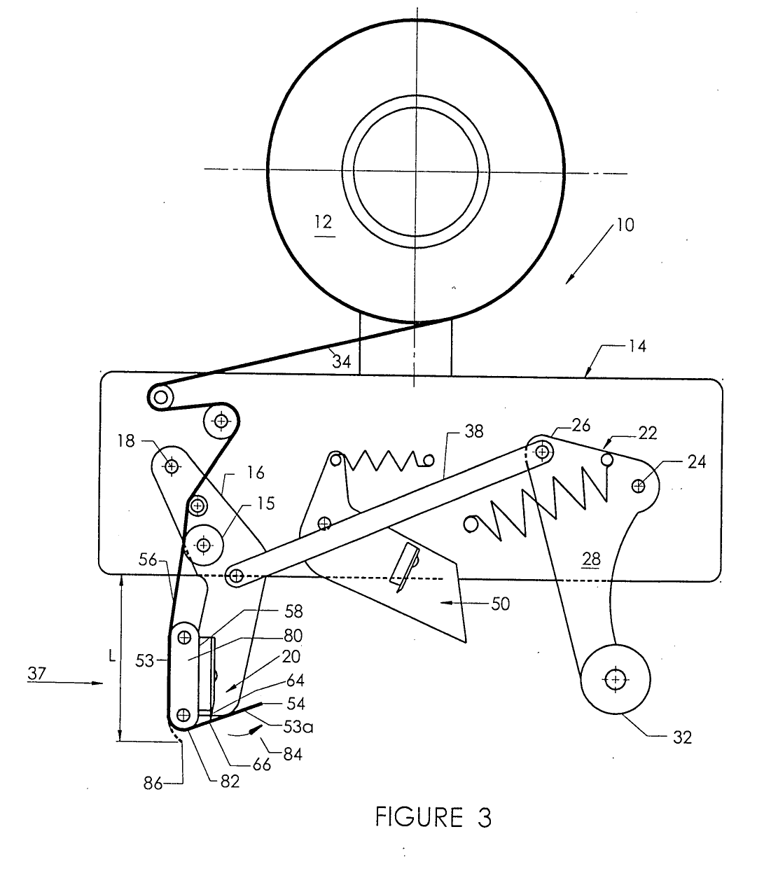

The wiper pad 60 is preferably, but not essentially flexible (see for example the FIG. 3 embodiment) and may be made of any suitable material such as rubber, polymer coated sponge material or the like. If the pad 60 is to be flexible as is preferred the pad must be made of material that is flexible so that it may be deformed for cutting the tape as shown in FIG. 2A and when not under such pressure resume it normal shape as shown in FIG. 2.

The new tape 34 (or free end of a broken tape) is treaded as described above however the free end 54 of the new tape 34 is cut off by deforming the pad 60 as shown in FIG. 2A so that the tape 34 is moved from its normal path 53, 53a against the edge 66 of the cutting element 64 to cut the tape 34 and leave the tab end 56 in position to be applied to the next box 36 to be sealed (see FIG. 2). The cutting edge 66 is positioned so that the free end edge 68 of tape 34 (which defines one end of the length of tab 56) formed when the new tape is cut off is position adjacent to the end 70 of the relaxed pad 60 as shown in dash lined in FIG. 2A.

In the FIG. 3 embodiment the flexible pad 60 is replace by a similar but thicker and thus less flexible wiper pad 80 having its fee end 82 rounded so that the grasped end 54 of the tape 34 may be pulled around the end 82 of the pad 80 as indicated by the arrow 84 out of the normal path 53a and moved into contact with the edge 66 of the cutting element 64 to form the free end edge 86 (shown in dash lines) of the tape 34 and define the free end of the tab 56 the location of which is determined by the positioning of the cutting element edge 66 and the thickness and curvature of the pad 80 which are set so that the end edge 86 is beyond the free end 82 of the pad 80 which is acceptable (after the first carton 36 has been taped the position of the corresponding fee end of the tape will be determined in the normal manner by the cut off mechanism 50.

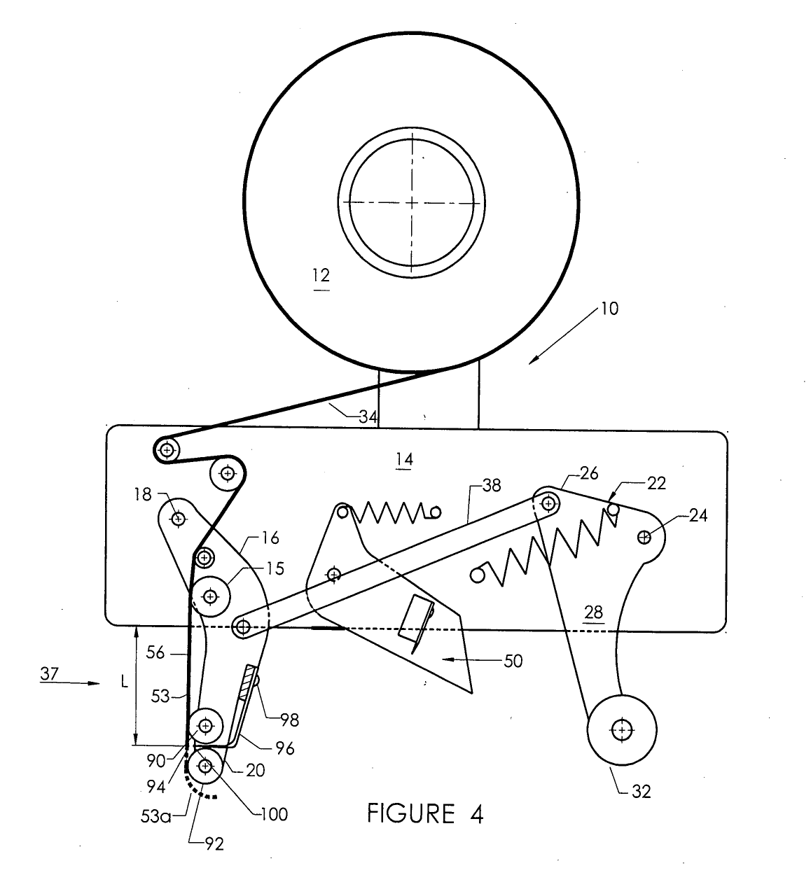

FIG. 4 shows yet another embodiment of the present invention wherein the pad 60 or 80 is replaced with a pair of rollers 90 and 92 that define a gap 94 therebetween. The cutting element 96 in this embodiment is preferably made of spring steel and is connected at its end adjacent to the pivot pin 18 to the arm 16 as indicated at 98. The element 96 is bent adjacent to its end remote form the connection 98 for form a cutting edge 100 that projects into the gap between the rolls 90 and 92. In its normal position the cutting edge 100 clears the path of the tape, however when a new roll is applied the tape is pulled over the rolls 90 and 92 and the cutting element is flexed to move the cutting edge 100 across the path of the tape 34 and sever the tape 34 and thereby define the end of the tab 56.

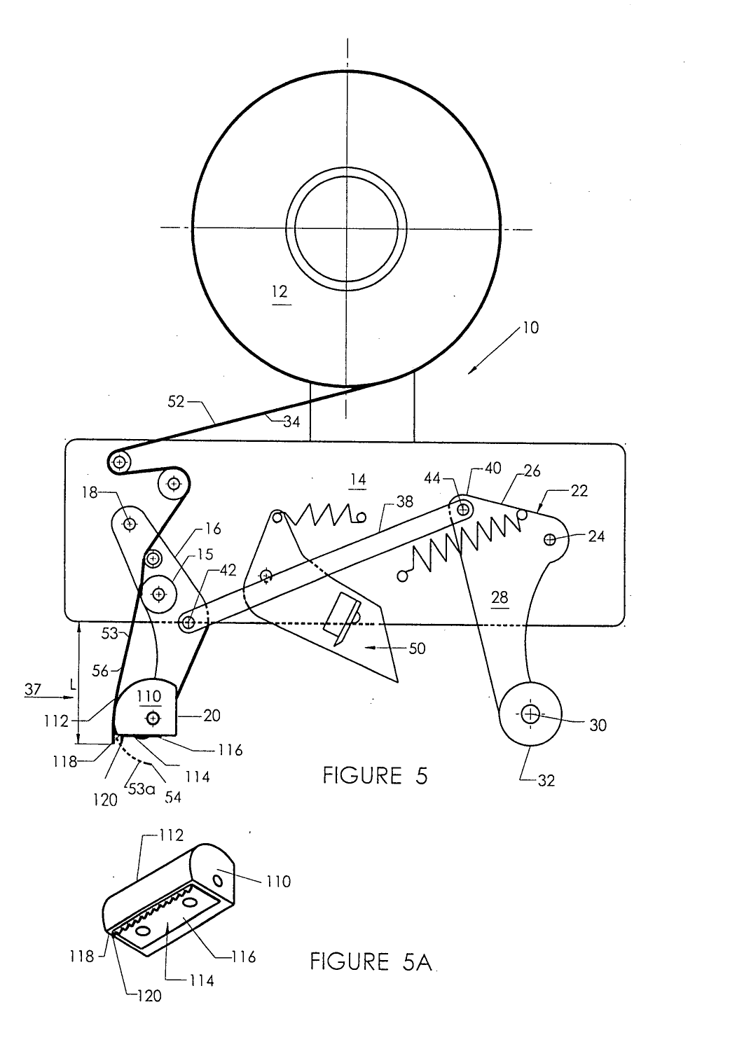

The fourth embodiment shown in FIGS. 5 and 5A is specifically designed for retrofitting existing tape heads i.e. to replace the roller 18 shown in FIG. 1 and is similar to the FIG. 3 embodiment but the pad 80 has been replaced by a curved pad 110 having a curved (preferably a segment of an arc of a circle) as indicated at 112 and has an L shaped cutting element 114 the mounting flange 116 mounted on a surface 118 of the pad 80 which surface preferably is substantially parallel to the direction of travel 37 when the taping head 10 is in inactive position as shown (i.e. before a box is moved into against the tape tab 56). The cutting edge 120 (equivalent to the edges 66, 110) of the cutting element 114 in the illustrated arrangement extends substantially perpendicular to the surface 118 and across the path of the tape end 54 so that the tape end grasped by the operator may be moved to sever the tape 34 to the proper length by bending around the pad 110 similar to the cutting operation with the FIG. 3 embodiment. It will be evident that the element 114 need not be L shaped but may be any convenient shape for mounting and positioning the edge 120 in a location to cut the tape to the desired length during the threading operation

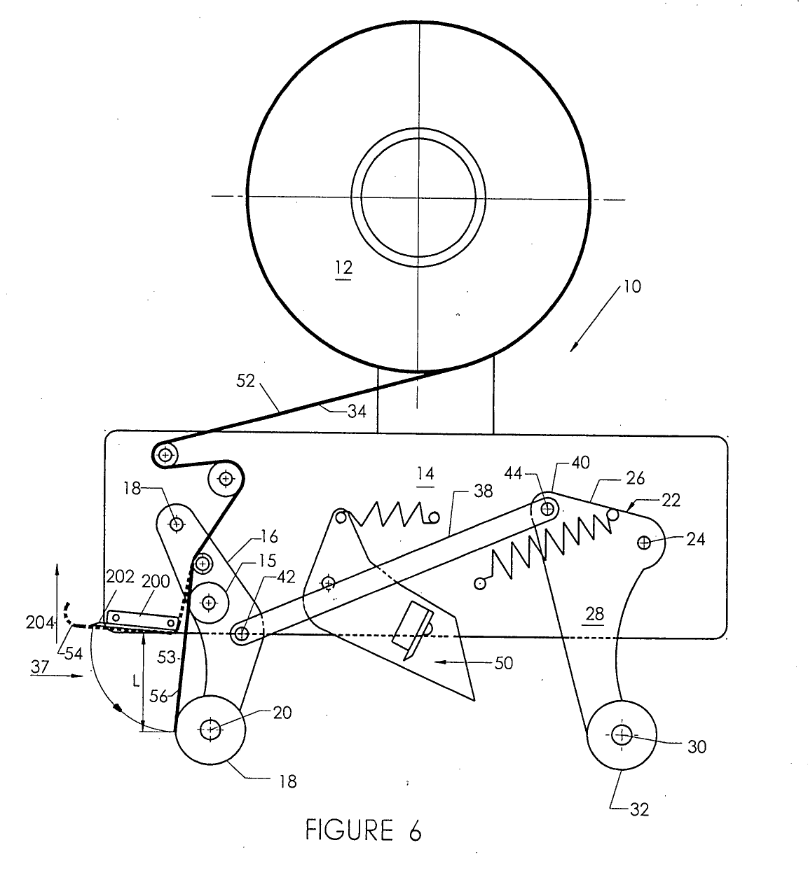

Turning to FIG. 6 the fifth illustrated embodiment takes the cutting element (equivalent to the cutting elements described above) from adjacent to the free end 20 of the leading arm 16 and mounts it as indicated at 200 in FIG. 6 on the frame 14 in front of the leading arm 16 and out of the normal path of travel of the tape 34. The cutting edge 202 of the element 200 is spaced from the normal path of the tape so that the cut length of the tape provides the required tab 56 of the appropriate length L.

In the FIG. 6 embodiment the end 54 of the tape 34 is pulled rearward relative to the direction of box travel as indicated by arrow 37 and then around the front of the frame 14 as indicated by the arrow 204 so that the tape traverses the edge 202 and is severed to the desired length.

It will be apparent that the frame 14 is normally a plate and the various elements are mounted cantilever fashion therefrom.

Having described the invention, modifications will be evident to those skilled in the art without departing from the scope of the invention as defined in the appended claims.

We claim:

1. A tape applicator having a front link and a rear link interconnected by a suitable frame, a first wiper for wiping a sealing tape against a carton being sealed in a tape sealing operation positioned at a free end of said front link remote from said frame, said rear link having a second wiper for wiping said sealing tape against a trailing end of said carton trailing in a direction of movement of said carton relative to said tape applicator during said sealing operation and a cut off knife for cutting said tape at the end of said taping operation, the improvement comprising a cutting element mounted on said applicator out of a normal path of said tape but relatively positioned so that relatively moving said tape and said cutting element during a threading operation to insert a tape into operative position in said applicator severs said tape at a location providing a tape tab have a length L to be applied to a leading face of a box to be taped.

2. A tape applicator as defined in claim 1 wherein said cutting element is mounted on said frame.

3. A tape applicator as defined in claim 1 wherein said cutting element is mounted on said front link adjacent to said first wiper.

4. A tape applicator as defined in claim 3 wherein said first wiper is a pad and said cutting element is positioned on a rear side of said pad opposite a side of said pad adjacent to a normal path of said sealing tape.

5. A tape applicator as defined in claim 4 wherein said cutting element has its cutting edge facing away from said frame.

6. A tape applicator as defined in claim 4 wherein said pad is a flexible pad that is deformed when said tape and cutting element are relatively moved to cut said tape.

7. A tape applicator as defined in claim 5 wherein said pad is a flexible pad that is deformed when said tape and cutting element are relatively moved to cut said tape.

8. A tape applicator as defined in claim 3 wherein said first wiper is composed of a pair of rollers spaced apart sufficiently for said cutting element to extend between them and wherein said cutting element is moved relative to said tape path into a cutting position for cutting said tape

9. A tape applicator as defined in claim 8 wherein said cutting element has a cutting edge that is a spring biased to an inactive position and is moveable from said inactive position to said cutting position.
